(19) United States
(12) Patent Application Publication
(10) Pub. No.: US 2019/0250407 A1
(43) Pub. Date: Aug. 15, 2019

(54) SEE-THROUGH RELAY FOR A VIRTUAL REALITY AND A MIXED ENVIRONMENT DISPLAY DEVICE

(71) Applicant: MICROSOFT TECHNOLOGY LICENSING, LLC, Redmond, WA (US)

(72) Inventors: Pierre Henri Rene DELLA NAVE, Seattle, WA (US); Richard Andrew WALL, Kirkland, WA (US)

(21) Appl. No.: 15/898,081

(22) Filed: Feb. 15, 2018

(51) Int. Cl. G02B 27/01; F21V 8/00; G09G 3/36; G06T 11/60

(52) U.S. Cl. CPC G02B 27/0172; G02B 6/0038; G02B 6/003; G09G 2340/12; G06T 11/60; G02B 2027/0138; G02B 2027/014; G09G 3/36

(57) ABSTRACT

Technologies described herein provide a display device having a see-through relay for providing a virtual reality and a mixed environment display. In some embodiments, an optical device includes a waveguide configured to operate as a periscope for receiving light from a real-world view. The light from the real-world view can be relayed to a user's eye(s) to overlay the real-world view on top of computer-generated images using minimal optical devices. This approach allows drastic cost, power consumption and weight reductions for devices that need to present mixed reality content to a user. This approach also allows for a great reduction in size of the holographic computer unit housing the optical device, as traditional systems may require a number of optical devices and computing power to shape the output of computer-generated images to properly overlay the real-world view with the images.

### BACKGROUND

Some devices include waveguides for providing near-to-eye display capabilities. For example, a head mounted display (“HMD”) can include waveguides to provide a single-eye display or a dual-eye display to a user. Some devices are designed to provide a computer-generated image (“CGI”) to a user, while other devices are designed to provide a mixed environment display, which includes superimposing a CGI over a real-world view. Thus, a user can see a real-world view of objects in their surrounding environment along with a CGI, a feature that is sometimes referred to as an “augmented reality display” because a user's view of the world can be augmented with a CGI. Although such devices are becoming more commonplace, developments to improve the sharpness of displayed images will continue to be a priority. In addition, there is a need for designs that improve the battery life, as well as a need to reduce the cost and weight, of such devices.

The disclosure made herein is presented with respect to these and other considerations.

### SUMMARY

Technologies described herein provide an optical device having a see-through relay for providing a virtual reality and a mixed environment display. In some embodiments, an optical device includes a waveguide configured to operate as a periscope that receives light from a real-world view. The light from the real-world view can be relayed to a user's eye(s) to overlay the real-world view on top of computer-generated images using a minimal number of optical components. This approach allows drastic cost, power consumption and weight reductions for devices that need to present mixed reality and/or virtual reality content to a user. This approach also allows for a great reduction in size of the holographic computer unit housing the optical device, as traditional systems may require a number of optical components and computing power to shape the light of computer-generated images to properly overlay the real-world view with the images.

In some configurations, a device comprises a waveguide having an input region for receiving a first light from a real-world view of a real-world object. The waveguide can be configured to direct the first light within the waveguide towards an output region of the waveguide. A controller can generate an output signal comprising image data defining image content, and a display device can generate a second light forming a field of view of the image content based on the output signal. A lens can direct the second light through a portion of the waveguide, wherein the output region directing the real-world view is aligned with the lens directing the second light from the display to create an output that concurrently displays the real-world view of the real-world object with the field of view of the CGI.

The techniques disclosed herein can provide both (1) an augmented reality display, e.g., a real-world view of natural light reflecting from a real-world object and a computer-generated rendering (e.g., “mixed reality”), and (2) a virtual reality display, which can include a fully computer-generated rendering. This can be achieved using fewer parts than most existing systems. For instance, this feature set can be achieved by simply blocking the input region of the see-through relay, blocking light of the real-world view. Thus, the display can become a virtual reality display only presenting rendered content. A blocking device can dynamically block and unblock light from the real-world view, thus enabling and disabling a path to the convergence of mixed reality and virtual reality in a single device that can be flipped between modes of operation.

It should be appreciated that the above-described subject matter may also be implemented as part of a computer-controlled apparatus, a computing system, part of an article of manufacture, or a process for making the same. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates aspects of an optical device including a waveguide that functions as a see-through relay for providing a virtual reality and a mixed environment display;

FIG. 2 illustrates aspects of another configuration of an optical device including a waveguide that functions as a relay for light from a real-world view;

FIG. 3A illustrates aspects of an optical device including a waveguide that functions as a relay for light from a real-world view, the device also comprising a blocking device;

FIG. 3B illustrates the optical device of FIG. 3A, showing a state of the blocking device that does not allow light from the real-world view to pass into the waveguide;

FIG. 4 illustrates aspects of an optical device having a waveguide having a second input region;

FIG. 5 illustrates an optical device having a lens with a variable focal distance;

FIG. 6 illustrates aspects of an optical device positioned in a predetermined position relative to a transparent surface to function as a heads-up display;

FIG. 7 shows an example computing system that may utilize aspects of the present disclosure;

FIG. 8 is a flowchart illustrating an example method for the optical device disclosed herein; and

FIG. 9 shows a block diagram of an example computing system.

### DETAILED DESCRIPTION

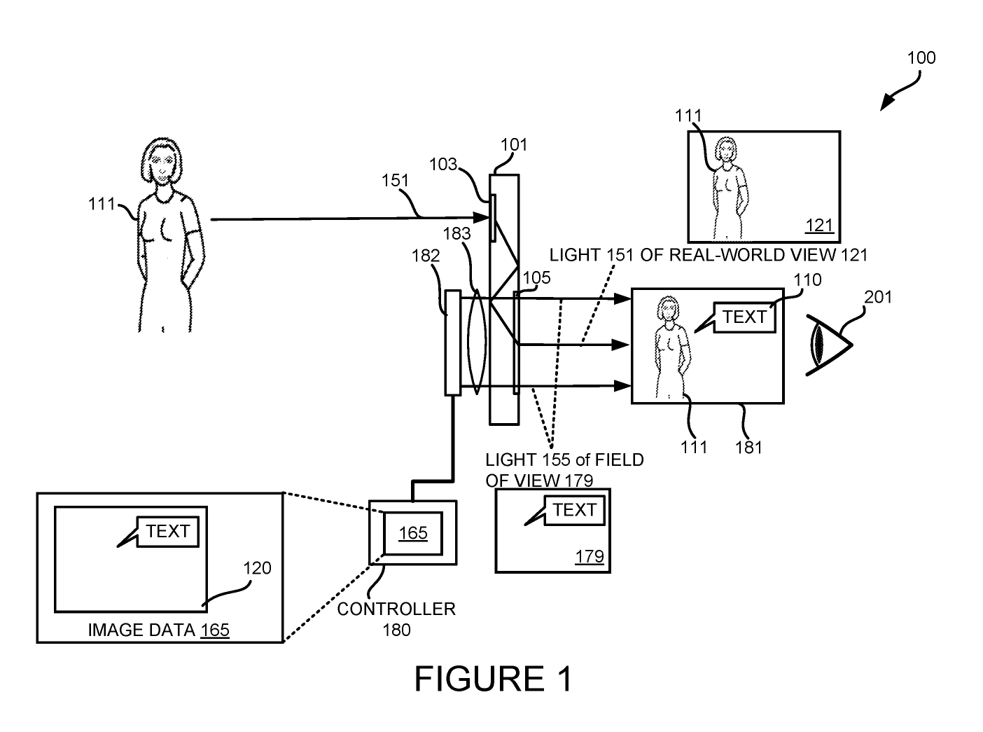

FIG. 1 schematically shows an example optical device 100 having a see-through relay for providing a virtual reality and a mixed environment display. In some configurations, the relay is in the form of a waveguide 101 having an input region 103 for receiving light 151 (also referred to herein as a “first light 151”) from a real-world view 121 of a real-world object 111. The input region 103 can be any suitable grating that captures light 151 of a real-world view and directs the light 151 within the waveguide 101 towards an output region 105. The optical device 100 can also include a controller 180 for generating an output signal comprising image data 165 defining image content 120. The optical device 100 can also include a display device 182 for generating a second light 155 forming a field of view 179 of the image content 120 based on the output signal. The optical device 100 can also include a lens 183 for directing the second light 155 through a portion of the waveguide 101. In some configurations, the output region 105 directing the first light 151 is aligned with the lens 183 directing the second light 155 to create an output 181 concurrently displaying the real-world view 121 of the real-world object 111 with the field of view 179, which can include a rendered object 110. In this example, the rendered object 110 includes displayed text. In some embodiments, the output region 105 includes a grating for directing the first light 151 toward at least one eye 201 of the user. In some embodiments, the grating also allows the second light 155 to pass through the waveguide 101 toward at least one eye 201 of the user.

The optical device 100, and the other optical devices disclosed herein, are configured to enable a user to simultaneously view objects from different environments. In some configurations, the optical device 100 can display image content 120, e.g., a computer-generated image (CGI) comprising a rendered object 110. In the example of FIG. 1, the first light 151 from a real-world view 121 includes a view of a real-world object 111, which can be a person or any other physical object. For illustrative purposes, the perspective from the user's eye 201 looking at real-world objects 111 through the relay of the optical device 100 is referred to herein as a “real-world view of a real-world object” or a “real-world view of a physical object.” A real-world object 111, for instance, may be a person standing in front of the optical device 100. The real-world object 111 and the rendered object 110 can be concurrently displayed to the user's eye 201.

The optical device 100 aligns the output region 105 with the display device 182 and/or a lens 183 to enable an output view 181, where the CGI of the content 120 is superimposed over the real-world view 121. For illustrative purposes, the output view 181 is referred to as a “mixed environment” display. To provide such features, the output region 105 and the lens 183 (also referred to herein as an “optical element 183”) are aligned to position, e.g., project, a rendered object 110 in a predetermined position relative to a view of a real-world object 111.

The second light 155 from the display device 182 can be directed by any type of optical element 183, which may be a lens, a wedge, a mirror, etc. The output 181 of the optical element 183 and the output region 105 can be directed to a user's eye 201. In the example shown in FIG. 1, the input region 103 is positioned on a first side of the waveguide 101, and the output region 105 is positioned on a second side, opposite the first side, of the waveguide 101.

In some configurations, the optical element 183 can have a predetermined focal distance or adjustable focal distance. For instance, the lens 183 can have a focal distance of −2. Such an example can give the user a perspective as if the display device 182 is two (2) feet from the user's eyes. This example is provided for illustrative purposes and is not to be construed as limiting. It can be appreciated that the lens can have any focal distance suitable for any desired application. An adjustable optical element 183, e.g., a lens, can have a range from 0 to −2, and the range can be controlled by the controller 180 or any other suitable computing device.

The display device 182 can be any suitable device for providing a rendering of image data. For instance, the display device 182 can be a flat panel display screen. The output region 105 can be any suitable grating that causes the first light 151 to exit the waveguide 101. In addition, the grating of the output region 105 can be configured to allow the second light 155 from the display device 182 to pass through the waveguide 101 toward at least one eye 201 of a user.

A design that relays the light of the real-world view, versus a design that relays the light of a CGI rendering, provides a number of advantages. For instance, prior designs that relay the light of a CGI rendering require a brighter display engine. By providing a design that does not require bright display engines, power savings at the display engine can be achieved. A display engine used by the techniques disclosed herein can be thinner and smaller in size. In addition, by providing a design that does not relay the light of a CGI rendering, the techniques disclosed herein do not require the use of light expanders or scanners. When light of a CGI rendering is propagated from an input region, through a waveguide, to an output region, such expanders and/or scanners are needed. Further, the techniques disclosed herein require fewer lenses. By providing a design that only requires one lens, embodiments having a single lens with a variable focal distance are possible.

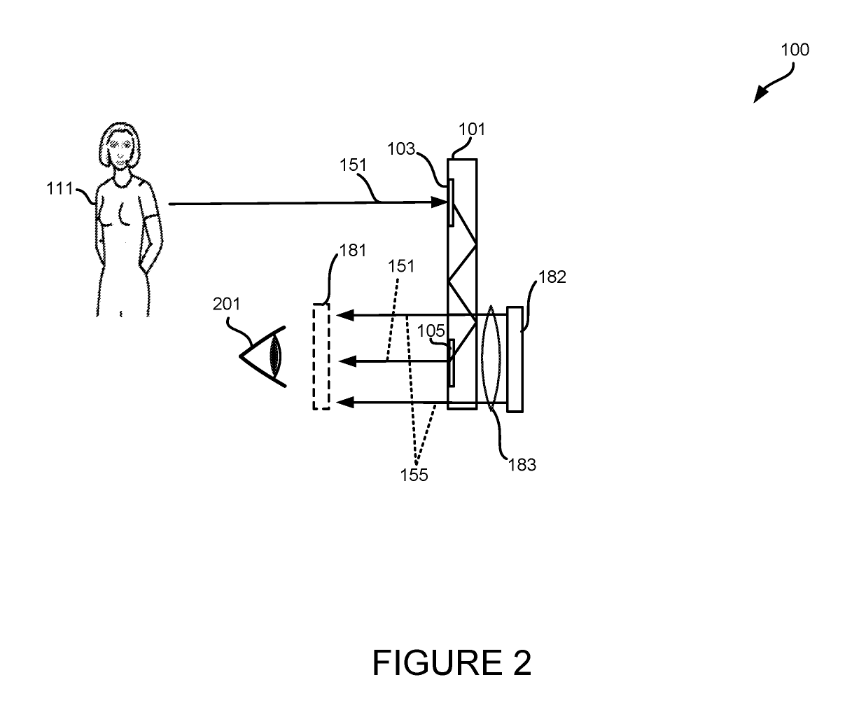

Referring now to FIG. 2, another configuration of an optical device 100 is shown and described below. In this example, the input region 103 and the output region 105 are positioned on the same side of the waveguide 101. The lens 183 directs the second light 155 from the display device 182 through a portion of the waveguide 101, and the output region 105 that directs the first light 151 is aligned with the lens 183 directing the second light 155 to create an output 181 concurrently displaying the real-world view of the real-world object 111 with the field of view generated by the display device 182, which can include a rendered object 110.

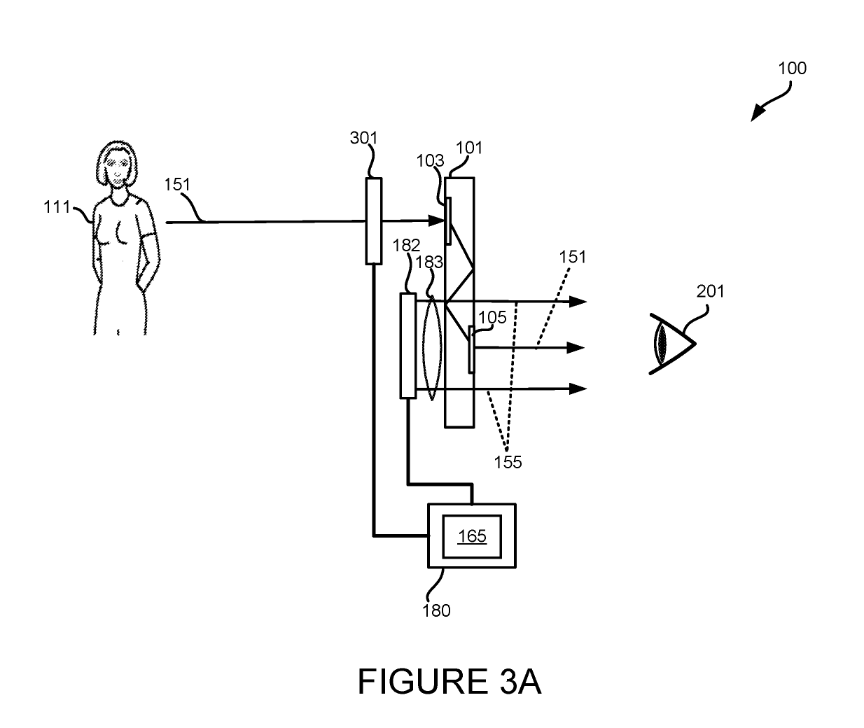

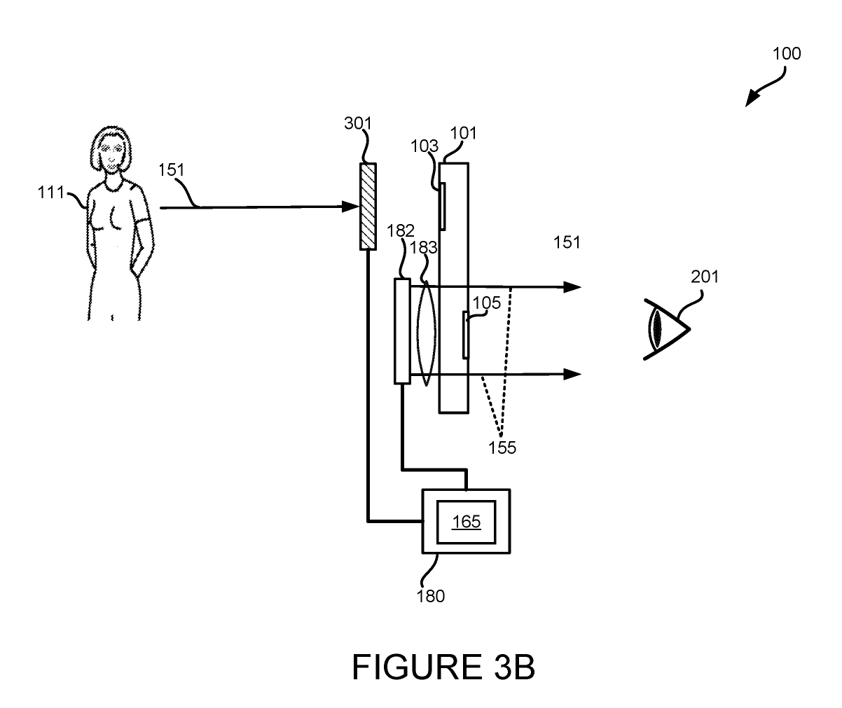

Referring now to FIG. 3A, another configuration of an optical device 100 is shown and described below. In this example, the optical device 100 comprises a blocking device 301 for receiving a control signal from the controller 180. The blocking device 301 is configured to block the first light 151 of the real-world view when the control signal is activated, and allow the passage of the first light 151 of the real-world view when the control signal is deactivated. This enables the device 100 to switch between an augmented reality system and a virtual reality system with minimal or inexpensive parts. The blocking device 301 can include any configuration that can block the passage of light. Some sample embodiments may include the use of a liquid crystal display (LCD). Thus, when the screen of the LCD is active, as shown in FIG. 3B, light is blocked and thus causes the device 100 to operate as a virtual reality system. As shown in FIG. 3B, when the first light 151 is blocked, the user only sees the second light 155 from the display device. When the screen of the LCD is inactive, as shown in FIG. 3A, the light of the real-world view can pass through the blocking device 301 and enable the device 100 to operate as a mixed environment system, allowing the user to see both the first light and the second light.

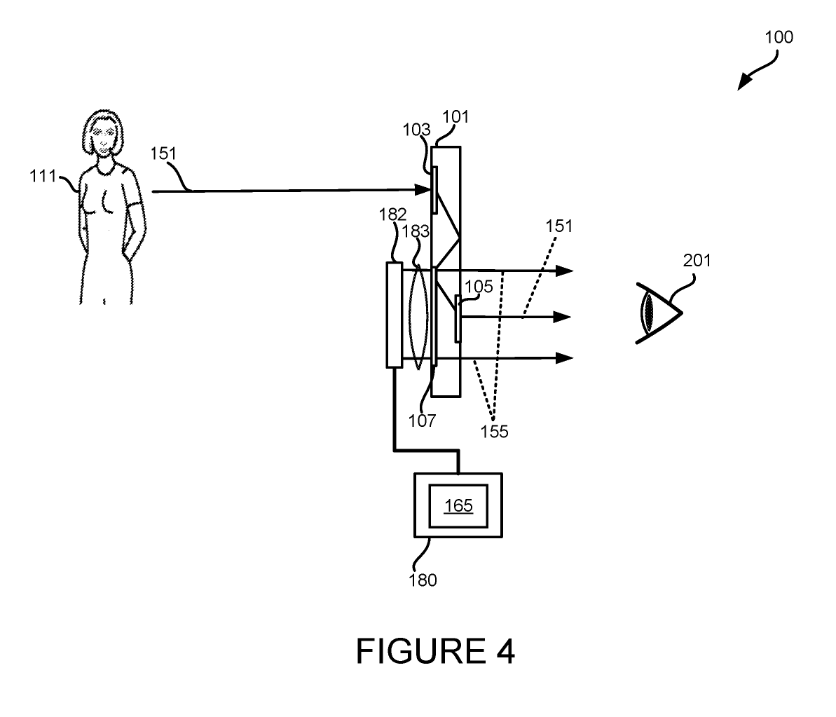

FIG. 4 illustrates aspects of an optical device having a waveguide having a second input region 107. In this example, a grating can be positioned to capture light from the display device 182. The grating of the second region 107 can be configured to direct the second light 155 from the display device 182 and/or the lens 183 toward a specific area, e.g., toward a user's eye(s) 201.

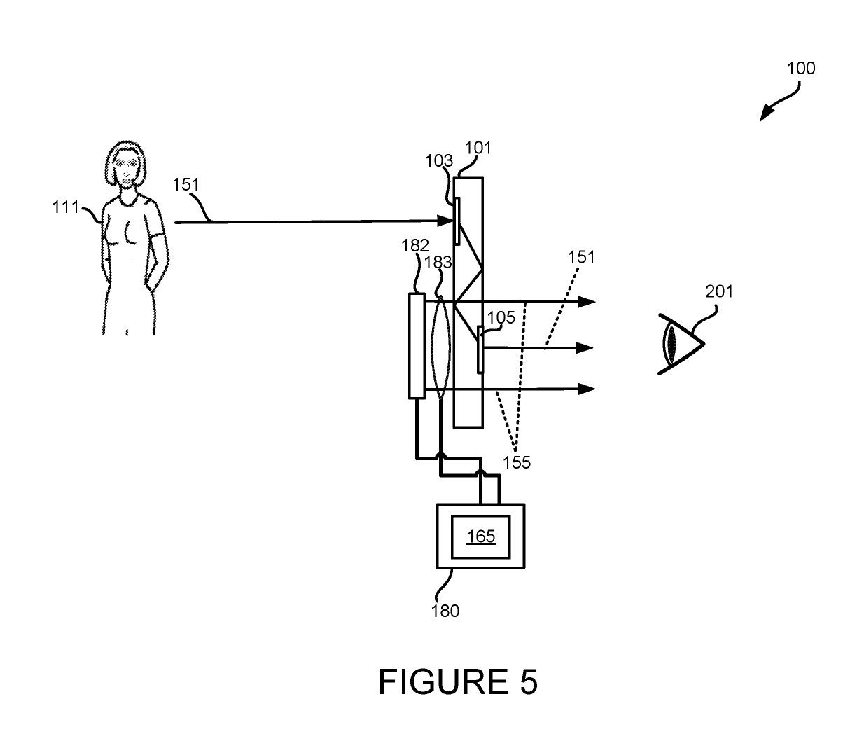

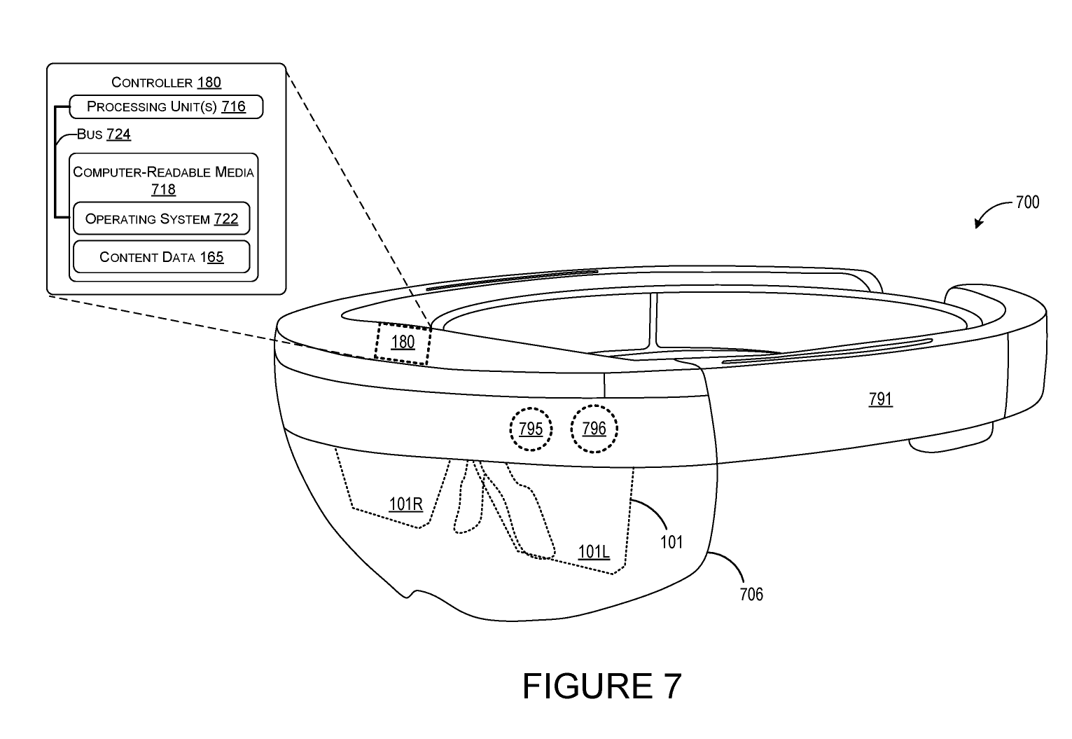

FIG. 5 illustrates an embodiment of an optical device 100 where the controller 180 is used to control a lens 183 with a variable focal distance. Such an embodiment can be used to dynamically change the focal distance of the lens 183 depending on a desired application. For instance, the focal distance of the lens 183 can be changed based on an input of a user, a preference file, aspects of the real-world view, and/or the content of the image data 165. In one illustrative example, the controller 180 or another computing device can analyze the content 120 and determine when the content 120 contains a specific scene type, e.g., a single person, a background image, a large crowd, etc. The focal distance of the lens 183 can be controlled based on such content. The controller 180 or another computing device can also analyze aspects of the real-world view, such as a size of real-world objects within the real-world view, a distance of the real-world objects from a sensor, properties of a scene, a type of scene, e.g., a view of a horizon versus a view of a person, etc. In such an embodiment, one or more cameras or sensors, such as those explained below with respect to FIG. 7, can generate image data or depth-map data of one or more real-world objects. Such data can be analyzed to determine a focal distance of the lens 183. In some configurations, the focal distance of the lens 183 can be based on a combination of factors, such as the content 120 and the aspects of the real-world view. In such configurations, the focal distance of the lens 183 can be controlled to coordinate the size of a rendered object relative to the size of a real-world object. The focal distance of the lens 183 can also be adjusted based on cues from real-world objects and/or rendered objects. For instance, an action, movement, gesture, position, or inaction of real-world objects and/or rendered objects can cause the focal distance of the lens to change. A relative distance between real-world objects and/or rendered objects can also cause the focal distance of the lens to change. The controller 180 or another computing device may adjust the focal distance based on the detection of certain scene types, or other properties of the content 120.

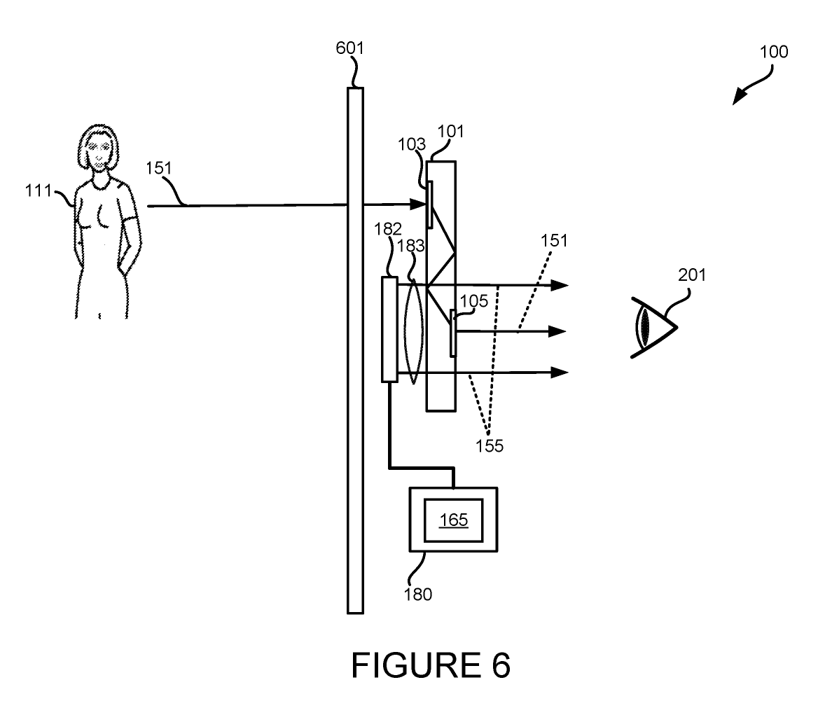

FIG. 6 illustrates another configuration of an optical device 100. In this example, the optical device 100 is positioned relative to, or mounted to, a transparent surface 601, which may include glass, plastic or any other suitable material. The transparent surface 601 can be, for instance a window of a building or a vehicle. This configuration enables a user to have a heads-up display, which provides a clear, real-time, view of the real-world object while also providing a CGI overlay to the real-world object. It can be appreciated that the optical device 100 shown in FIG. 3A can also be positioned relative to, or mounted to, a transparent surface 601.

FIG. 7 shows an example computing system in the form of a head-mounted display (HMD) 700 that may utilize the optical device 100. The head-mounted display 700, which is also referred to herein as a “computing system 700” includes a frame 791 in the form of a band wearable around a head of a user that supports see-through display componentry positioned near the user's eyes. The head-mounted display 700 may utilize augmented reality technologies to enable simultaneous viewing of virtual display imagery and a view of a real-world background. As such, the head-mounted display 700 is configured to generate virtual images via see-through relays 101. The see-through relays 101, as depicted, can include separate right eye and left eye relays 101R and 101L. In other examples, a see-through display may have a single display viewable with both eyes. The see-through relay 101 can be in any suitable form, such as a waveguide, a number of waveguides, or one or more prisms configured to receive a generated image and direct the image towards a wearer's, e.g., a user's, eye. The see-through relays 101 may include any suitable light source for generating images, such as the waveguides and other components disclosed herein.

The head-mounted display 700 further includes an additional see-through optical component 706, shown in FIG. 7 in the form of a see-through veil positioned between see-through relay 101 and the background environment as viewed by a wearer. A controller 180 is operatively coupled to the see-through relay 101, e.g., the optical component 101, and to other display componentry. The controller 180 includes one or more logic devices and one or more computer memory devices storing instructions executable by the logic device(s) to enact functionalities of the display device. The controller 180 can comprise one or more processing unit(s) 716, computer-readable media 718 for storing an operating system 722 and data, such as content data 165. As will be described in more detail below, the computing system 700 can also include a linear light source and one or more scanning devices. The components of computing system 700 are operatively connected, for example, via a bus 724, which can include one or more of a system bus, a data bus, an address bus, a PCI bus, a Mini-PCI bus, and any variety of local, peripheral, and/or independent buses.

The processing unit(s), processing unit(s) 716, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

As used herein, computer-readable media, such as computer-readable media 718, can store instructions executable by the processing unit(s). Computer-readable media can also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media can include computer storage media and/or communication media. Computer storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, rotating media, optical cards or other optical storage media, magnetic storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media can embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

The head-mounted display 700 may further include various other components, for example a two-dimensional image camera 795 (e.g. a visible light camera and/or infrared camera) and a depth camera 796, as well as other components that are not shown, including but not limited to eye-gaze detection systems (e.g. one or more light sources and eye-facing cameras), speakers, microphones, accelerometers, gyroscopes, magnetometers, temperature sensors, touch sensors, biometric sensors, other image sensors, energy-storage components (e.g. battery), a communication facility, a GPS receiver, etc.

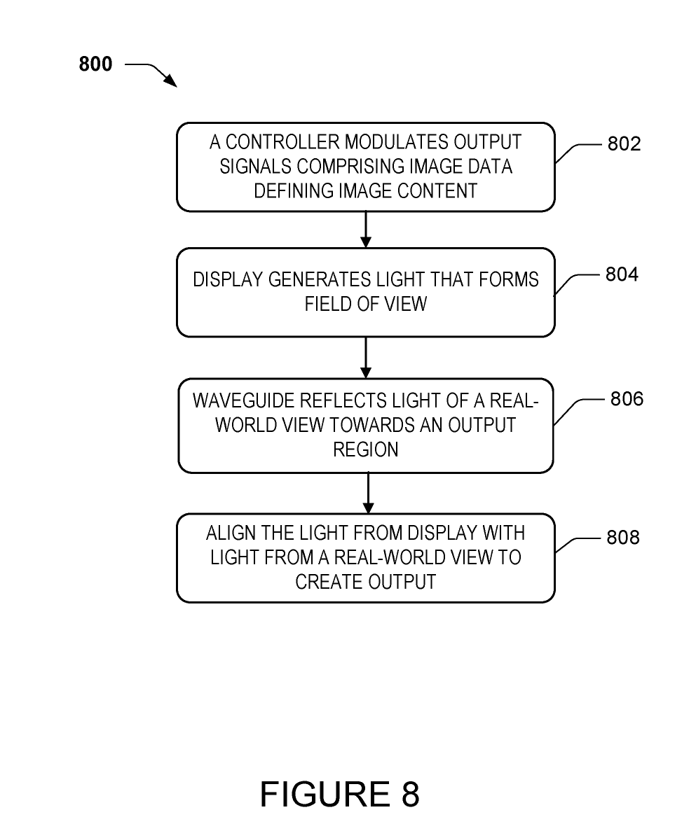

FIG. 8 shows an example method 800 for providing the techniques disclosed herein. The method 800 includes, as shown in block 802, an operation where the controller 180 generates or modulates one or more output signals comprising image data 165 defining image content 120. As shown in block 804, a display device generates light that forms a field of view of the image content 120 based on the one or more output signals.

Next, as shown in block 806, a waveguide 101 receives input light from a real-world view of an object 111. The input light from the real-world view can be directed from an input region, through the waveguide, to an output region of the waveguide.

Next, as shown in block 808, the waveguide 102 aligns the light emitting from the output region 105 with a lens 183 directing light 151 from a real-world view 121 to create an output 181 concurrently displaying a real-world view 121 with the generated field of view 179. In some configurations, the output region 105 and the lens 183 are aligned to project a rendered object 110 in a predetermined position relative to a view of a real-world object 111.

While described herein in the context of near-eye display systems, the example optical systems and methods disclosed herein may be used in any suitable optical system, such as a rifle scope, telescope, spotting scope, binoculars, and heads-up display.

In some embodiments, the methods and processes described herein may be tied to a computing system of one or more computing devices. In particular, such methods and processes may be implemented as a computer-application program or service, an application-programming interface (API), a library, and/or other computer-program product.

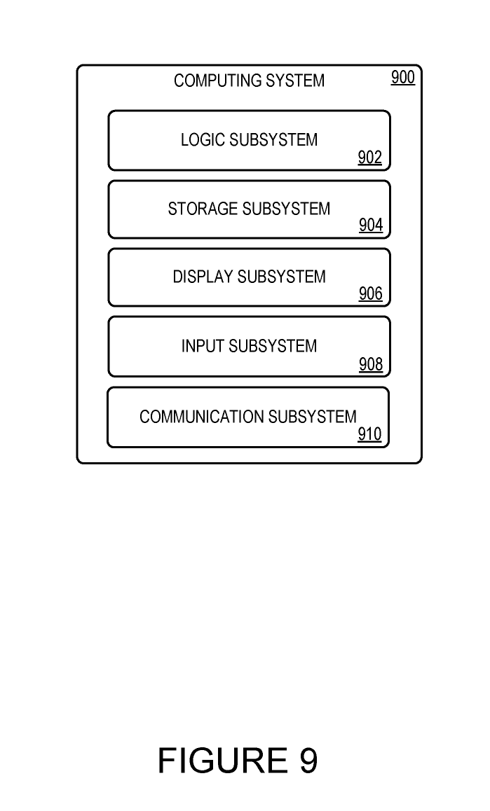

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic subsystem 902 and a storage subsystem 904. Computing system 900 may optionally include a display subsystem 906, input subsystem 908, communication subsystem 910, and/or other components not shown in FIG. 9.

Logic subsystem 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 902 may include one or more processors configured to execute software instructions. Additionally or alternatively, logic subsystem 902 may include one or more hardware or firmware logic machines configured to execute hardware or firmware instructions. Processors of logic subsystem 902 may be single-core or multi-core, and the instructions executed thereon may be configured for sequential, parallel, and/or distributed processing. Individual components of logic subsystem 902 optionally may be distributed among two or more separate devices, which may be remotely located and/or configured for coordinated processing. Aspects of logic subsystem 902 may be virtualized and executed by remotely accessible, networked computing devices configured in a cloud-computing configuration.

Storage subsystem 904 includes one or more physical devices configured to hold instructions executable by logic subsystem 902 to implement the methods and processes described herein. When such methods and processes are implemented, the state of storage subsystem 904 may be transformed—e.g., to hold different data.

Storage subsystem 904 may include removable and/or built-in devices. Storage subsystem 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 904 may include volatile, nonvolatile, dynamic, static, read/write, read-only, random-access, sequential-access, location-addressable, file-addressable, and/or content-addressable devices.

It will be appreciated that storage subsystem 904 includes one or more physical devices. However, aspects of the instructions described herein alternatively may be propagated by a communication medium (e.g., an electromagnetic signal, an optical signal, etc.) as opposed to being stored on a storage medium.

Aspects of logic subsystem 902 and storage subsystem 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 906 may be used to present a visual representation of data held by storage subsystem 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic subsystem 902 and/or storage subsystem 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

This disclosure also includes the following examples:

### Example 1

An optical device (100), comprising: a waveguide (101) having an input region (103) for receiving a first light (151) from a real-world view (121) of a real-world object (111), the waveguide (101) reflecting the first light (151) within the waveguide (101) towards an output region (105); a controller (180) generating an output signal comprising image data (165) defining image content (120); a display device (182) generating a second light (155) forming a field of view (179) of the image content (120) based on the output signal; a lens (183) for directing the second light (155) through a portion of the waveguide (101), wherein the output region (105) directing the first light (151) is aligned with the lens (183) directing the second light (155) to create an output (181) concurrently displaying the real-world view (121) of the real-world object (111) with the field of view (179).

### Example 2

The optical device of example 1, wherein the output region (105) and the lens (183) are aligned to position a rendered object (110) in a predetermined position relative to a view of the real-world object (111).

### Example 3

The optical device of examples 1-2, wherein the input region (103) is positioned on a first side of the waveguide (101), and the output region (105) is positioned on a second side of the waveguide (101).

### Example 4

The optical device of examples 1-3, wherein the input region (103) and the output region (105) are positioned on a first side of the waveguide (101).

### Example 5

The optical device of examples 1-4, wherein the lens (183) directs the first light (151) and the second light (155) toward at least one eye (201) of a user.

### Example 6

The optical device of examples 1-5, wherein the output region (105) comprises a grating for directing the first light (151) toward at least one eye (201) of a user, the grating also allowing the second light (155) to pass through the waveguide (101) toward at least one eye (201) of the user.

### Example 7

The optical device of examples 1-6, further comprising a blocking device (301) for receiving a control signal from the controller (180), the blocking device (301) configured to block the first light (151) of the real-world view (121) when the control signal is activated and allow the passage of the first light (151) of the real-world view (121) when the control signal is deactivated.

### Example 8

An optical device (100), comprising: a waveguide (101) having an input region (103) for receiving a first light (151) from a real-world view (121) of a real-world object (111), the waveguide (101) reflecting the first light (151) within the waveguide (101) towards an output region (105); a blocking device (301) for receiving a first control signal, wherein the blocking device (301) prevents the first light (151) from entering the input region (103) when the first control signal is activated, and wherein the blocking device (301) allows the first light (151) to enter the input region (103) when the first control signal is deactivated; a controller (180) generating an output signal comprising image data (165) defining image content (120); a display device (182) generating a second light (155) forming a field of view (179) of the image content (120) based on the output signal; a lens (183) for directing the second light (155) through a portion of the waveguide (101), wherein the lens varies a focal distance based on a second control signal received at the lens (183), wherein the output region (105) directing the first light (151) is aligned with the lens (183) directing the second light (155) to create an output (181) concurrently displaying the real-world view (121) of the real-world object (111) with the field of view (179).

### Example 9

The optical device of example 8, wherein the output region (105) and the lens (183) are aligned to position a rendered object (110) in a predetermined position relative to a view of the real-world object (111).

### Example 10

The optical device of examples 8 and 9, wherein the input region (103) is positioned on a first side of the waveguide (101), and the output region (105) is positioned on a second side of the waveguide (101).

### Example 11

The optical device of examples 8 through 10, wherein the input region (103) and the output region (105) are positioned on a first side of the waveguide (101).

### Example 12

The optical device of examples 8 through 11, wherein the lens directs the first light (151) and the second light (155) toward at least one eye (201) of a user, and wherein the output region (105) comprises a grating for directing the first light (151) toward at least one eye (201) of a user, the grating also allowing the second light (155) to pass through the waveguide (101) toward at least one eye (201) of the user.

### Example 13

An optical device (100), comprising: a waveguide (101) having an input region (103) for receiving a first light (151) from a real-world view (121) of a real-world object (111), the waveguide (101) reflecting the first light (151) within the waveguide (101) towards an output region (105); a blocking device (301) for receiving a control signal, wherein the blocking device prevents the first light (151) from entering the input region (103) when the control signal is activated, and wherein the blocking device (301) allows the first light (151) to enter the input region when the control signal is deactivated; a controller (180) generating an output signal comprising image data (165) defining image content (120); a display device (182) generating a second light (155) forming a field of view (179) of the image content (120) based on the output signal; a lens (183) for directing the second light (155) through a portion of the waveguide (101), wherein the output region (105) directing the first light (151) is aligned with the lens (183) directing the second light (155) to create an output (181) concurrently displaying the real-world view (121) of the real-world object (111) with the field of view (179).

### Example 14

The optical device of example 13, wherein the output region (105) and the lens (183) are aligned to position a rendered object (110) in a predetermined position relative to a view of the real-world object (111).

### Example 15

The optical device of examples 13 and 14, wherein the input region (103) is positioned on a first side of the waveguide (101), and the output region (105) is positioned on a second side of the waveguide (101).

### Example 16

The optical device of examples 13 through 15, wherein the input region (103) and the output region (105) are positioned on a first side of the waveguide (101).

### Example 17

The optical device of examples 13 through 16, wherein the lens directs the first light (151) and the second light (155) toward at least one eye (201) of a user.

### Example 18

The optical device of examples 13 through 17, wherein the output region (105) comprises a grating for directing the first light (151) toward at least one eye (201) of a user, the grating also allowing the second light (155) to pass through the waveguide (101) toward at least one eye (201) of the user.

### Example 19

The optical device of examples 13 through 18, wherein the lens (183) has a variable focal distance that is adjusted by a lens control signal generated by the controller (180), wherein the controller (180) analyzes the content and modifies the focal distance based on the content of the image data (165).

### Example 20

The optical device of examples 1 through 7, wherein the lens (183) has a variable focal distance that is adjusted by a lens control signal generated by the controller (180).

Based on the foregoing, it should be appreciated that concepts and technologies have been disclosed herein that provide formable interface and shielding structures. Although the subject matter presented herein has been described in language specific to some structural features, methodological and transformative acts, and specific machinery, it is to be understood that the invention defined in the appended claims is not necessarily limited to the specific features or acts described herein. Rather, the specific features and acts are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. An optical device, comprising:
a waveguide having an input region for receiving a first light from a real-world view of a real-world object, the waveguide reflecting the first light within the waveguide towards an output region;
a controller generating an output signal comprising image data defining image content;
a display device generating a second light forming a field of view of the image content based on the output signal;
a lens for directing the second light through a portion of the waveguide, wherein the output region directing the first light is aligned with the lens directing the second light to create an output concurrently displaying the real-world view of the real-world object with the field of view.

2. The optical device of claim 1, wherein the output region and the lens are aligned to position a rendered object in a predetermined position relative to a view of the real-world object.

3. The optical device of claim 1, wherein the input region is positioned on a first side of the waveguide, and the output region is positioned on a second side of the waveguide.

4. The optical device of claim 1, wherein the input region and the output region are positioned on a first side of the waveguide.

5. The optical device of claim 1, wherein the lens directs the first light and the second light toward at least one eye of a user.

6. The optical device of claim 1, wherein the output region comprises a grating for directing the first light toward at least one eye of a user, the grating also allowing the second light to pass through the waveguide toward at least one eye of the user.

7. The optical device of claim 1, further comprising a blocking device for receiving a control signal from the controller, the blocking device configured to block the first light of the real-world view when the control signal is activated and allow the passage of the first light of the real-world view when the control signal is deactivated.

8. The optical device of claim 1, wherein the lens has a variable focal distance that is adjusted by a lens control signal generated by the controller.

9. An optical device, comprising:
a waveguide having an input region for receiving a first light from a real-world view of a real-world object, the waveguide reflecting the first light within the waveguide towards an output region;
a blocking device for receiving a control signal, wherein the blocking device prevents the first light from entering the input region when the control signal is activated, and wherein the blocking device allows the first light to enter the input region when the control signal is deactivated;
a controller generating an output signal comprising image data defining image content;
a display device generating a second light forming a field of view of the image content based on the output signal;
a lens for directing the second light through a portion of the waveguide, wherein the output region directing the first light is aligned with the lens directing the second light to create an output concurrently displaying the real-world view of the real-world object with the field of view.

10. The optical device of claim 9, wherein the output region and the lens are aligned to position a rendered object in a predetermined position relative to a view of the real-world object.

11. The optical device of claim 9, wherein the input region is positioned on a first side of the waveguide, and the output region is positioned on a second side of the waveguide.

12. The optical device of claim 9, wherein the input region and the output region are positioned on a first side of the waveguide.

13. The optical device of claim 9, wherein the lens directs the first light and the second light toward at least one eye of a user.

14. The optical device of claim 9, wherein the output region comprises a grating for directing the first light toward at least one eye of a user, the grating also allowing the second light to pass through the waveguide toward at least one eye of the user.

15. The optical device of claim 9, wherein the lens has a variable focal distance that is adjusted by a lens control signal generated by the controller, wherein the controller analyzes the content and modifies the focal distance based on the content of the image data or at least one aspect of the real-world object.

16. An optical device, comprising:
a waveguide having an input region for receiving a first light from a real-world view of a real-world object, the waveguide reflecting the first light within the waveguide towards an output region;
a blocking device for receiving a first control signal, wherein the blocking device prevents the first light from entering the input region when the first control signal is activated, and wherein the blocking device allows the first light to enter the input region when the first control signal is deactivated;
a controller generating an output signal comprising image data defining image content;
a display device generating a second light forming a field of view of the image content based on the output signal;
a lens for directing the second light through a portion of the waveguide, wherein the lens varies a focal distance based on a second control signal received at the lens, wherein the output region directing the first light is aligned with the lens directing the second light to create an output concurrently displaying the real-world view of the real-world object with the field of view.

17. The optical device of claim 16, wherein the output region and the lens are aligned to position a rendered object in a predetermined position relative to a view of the real-world object.

18. The optical device of claim 16, wherein the input region is positioned on a first side of the waveguide, and the output region is positioned on a second side of the waveguide.

19. The optical device of claim 16, wherein the input region and the output region are positioned on a first side of the waveguide.

20. The optical device of claim 16, wherein the lens directs the first light and the second light toward at least one eye of a user, and wherein the output region comprises a grating for directing the first light toward at least one eye of a user, the grating also allowing the second light to pass through the waveguide toward at least one eye of the user.
